(19) United States
(12) Patent Application Publication
(10) Pub. No.: US 2013/0017299 A1
(43) Pub. Date: Jan. 17, 2013

(54) STABLE DISPERSION OF STEROLS IN AQUEOUS SOLUTIONS COMPRISING AN OIL

(71) Applicants: MICHAEL JONATHAN DOBY, Wilmington, DE (US); ERIC P. HOLOWKA, Philadelphia, PA (US); DANIEL ALBERT GREEN, Media, PA (US)

(72) Inventors: MICHAEL JONATHAN DOBY, Wilmington, DE (US); ERIC P. HOLOWKA, Philadelphia, PA (US); DANIEL ALBERT GREEN, Media, PA (US)

(73) Assignee: E I DU PONT DE NEMOURS AND COMPANY, Wilmington, DE (US)

(21) Appl. No.: 13/546,664

(22) Filed: Jul. 11, 2012

Related U.S. Application Data
(60) Provisional application No. 61/506,725, filed on Jul. 12, 2011.
(60) Provisional application No. 61/506,723, filed on Jul. 12, 2011.

(51) Int. Cl. A23D 7/00; A23D 7/04; A23D 9/00; A23L 2/38; A23C 13/00; A23C 15/00

(52) U.S. Cl. 426/238; 426/602; 426/586; 426/581; 426/608; 426/590

(57) ABSTRACT

A stable dispersion and a process of preparing a stable dispersion of one or more sterols in an aqueous solution are disclosed. An oil component is used as a carrier and is mixed with the one or more sterols in suspension to facilitate dispersion of the sterol in the aqueous solution. The aqueous solution may be an alcoholic solution. Freezing the stable dispersion of one or more sterols in the aqueous solution provides for a ready-to-pour frozen slush beverage.

### FIELD OF INVENTION

The present invention relates to preparation of a stable dispersion of particles in an aqueous solution. In particular the invention relates to the preparation of stable dispersions of sterol particles in an aqueous solution.

### BACKGROUND

Supercooling of water and many aqueous solutions before freezing is well-known. These liquids must be often cooled many degrees below their melting points before ice forms. This affects many popular products and some industrial and agricultural processes.

For example, the frozen beverage and treat market is global, with frozen soft drinks, cocktails, and flavored ices being popular choices across many markets. Such products contain dispersions of ice in a liquid, which typically contains flavoring, sweetener, and other additives. Preparation of frozen beverages can be labor intensive, requiring the use of equipment such as scraped-surface slush machines (e.g. Slush Puppy™) to produce small ice crystals or a blender to reduce ice cubes to small ice particles. Such equipment is inconvenient to use and thus often avoided by consumers. Therefore, several products with the intention to address convenience, with the ability to freeze in a static domestic freezer and deliver a soft-ice have been marketed. However, these products suffer from supercooling without freezing, particularly given the temperature fluctuations often observed in domestic freezers. For example, in the warmer domestic freezers, they either cannot form ice, or form an insufficient amount of ice, resulting in a cold beverage with a small amount of floating ice particles. Further, products meant to maintain pourability or a soft texture fail in the colder freezers due to over-hardening, which can occur in as little time as leaving the products in the freezer overnight, thus requiring a thaw step prior to dispensing. This could involve waiting for the product to partially melt, or inducing such melting through adding heat by microwave treatment or manipulation by hand (U.S. Pat. No. 5,853,785).

WO96/11578 discloses a ready-to-freeze alcoholic beverage where the product must be removed from the container by a hand-operated utensil, such as a spoon.

WO2010/146392 discloses a slush beverage formulation and method for preparing same that, once reaching a steady-state temperature in a freezer, results in a pourable slush.

U.S. patent application Ser. No. 13/423,371, filed Mar. 19, 2012, discloses a process to prepare an anhydrous form of stigmasterol having superior ice-nucleating properties, for example, stable nucleation and reproducibility, batch-to-batch, and use of such stigmasterol in a frozen slush beverage. This application discloses adding anhydrous stigmasterol as a solid to prepare the frozen slush beverage.

To reliably freeze beverage solutions in domestic freezers (which possess a diverse range of freezer temperatures typically from −11° C. to −20° C.) an ice nucleating agent can be supplied. Sterols have been used as a class of nucleating agents for this purpose. The commercially available sterols (e.g., stigmasterol) are generally solid particles and have very low solubility in water and do not readily disperse. Sterol particles can be in a solvated form (e.g., from an ethanol solvent), a hydrated form, an anhydrous form, or combinations thereof. When added to an aqueous solution, sterol particles either rapidly rise to the surface or settle to the bottom of the container. Thus, the commercially available sterols cannot be readily dispersed in aqueous solutions and as such including them in formulations represents a challenge. For example, beverage bottling lines at manufacturing facilities operate at very high speeds (i.e., 150-200 bottles per minute) thus making addition of equal concentrations of insoluble ingredients to each bottle difficult. To address this challenge, dosing the stigmasterol has been examined by either using the inconvenient approach of a screw or disk feeder or pressing the stigmasterol into tablets and feeding single tablets into each bottle, each method resulting in slowing down the bottling process. Additionally, in cases where sterols are not stably dispersed, when the slush beverage thaws, they tend to float to the surface of the aqueous solution thus providing for a non-appealing presence possibly resulting in customer rejection, as may be encountered in the beverage products of WO2010/146392 and U.S. patent application Ser. No. 13/423,371.

U.S. Pat. No. 5,239,819 discloses use of a water stable crystalline hydrated form of sterol nucleators to provide predictable nucleation temperatures which are stable for repeated use in equipment such as commercial ice making systems.

Thus a need remains for a product that provides a stable aqueous dispersion at ambient temperature, and consistently freezes over a wide range of temperatures, commonly encountered in domestic and commercial freezers. The present disclosure offers a solution to this problem.

Potential applications for this technology beyond frozen beverages and treats include any situation in which water or an aqueous solution needs to freeze without significant undercooling, particularly when the sterol needs to be uniformly distributed throughout the liquid to ensure uniform dosing into containers or uniform dispersion in larger quantities. For example, frozen foods and even water sprayed onto fruit trees to protect them during spring frosts.

### SUMMARY OF INVENTION

The invention provides for a stable dispersion of one or more sterols comprising, consisting essentially of, or consisting of:
a) a suspension of one or more sterols in one or more oil components; and
b) an aqueous solution,
   wherein the one or more oil component is an animal oil, a plant oil, a mineral oil or a combination of two or more thereof.

In an aspect of the invention, the stable dispersion has 1 to 1500 mg sterol per liter (sterol/l) and from 3.3 mg to 50 g oil component per liter (oil component/l).

In another aspect of the invention, the one or more sterols in the aqueous solution remain dispersed during storage for a period of at least 4 hours; typically much longer, such as, for example, at least one month, or at least two months, or at least three months. The one or more sterols in the aqueous solution remain dispersed during storage for periods even longer than 6 months.

In another aspect of the invention, the one or more sterols is stigmasterol.

In a further aspect of the invention, the one or more oil component is rapeseed oil.

In a further aspect of the invention, the one or more oil component is dairy cream.

The invention further provides a process for preparing a stable dispersion of one or more sterols comprising, consisting essentially of, or consisting of:
a) combining one or more sterols with one or more oil components, to produce a sterol/oil suspension wherein the one or more oil component is an animal oil, a plant oil, a mineral oil or a combination of two or more thereof;
b) combining the sterol/oil suspension with an aqueous solution to produce a mixture of sterol/oil/aqueous solution;
c) agitating the mixture of sterol/oil/aqueous solution to produce an unstable dispersion of sterol/oil/aqueous solution; and
d) homogenizing the unstable dispersion of step (c) to produce a stable dispersion of the one or more sterols in the aqueous solution.

### DETAILED DESCRIPTION OF INVENTION

The present invention provides a stable dispersion and a process for producing the stable dispersion. The stable dispersion may be in the form of a beverage that can be purchased by a consumer in liquid form as a shelf-stable, ready-to-freeze beverage. The ready-to-freeze beverage remains liquid at room temperature, is stable upon storage, and when placed in a domestic or other conventional freezer for a period of time, such as about 6 hours or longer, the liquid forms a ready-to-pour frozen slush beverage. The beverage maintains its ability to form a ready-to-pour frozen slush beverage after production, transportation, and storage in retail outlets and home environments at a wide range of conditions.

In one embodiment of this invention there is provided a stable dispersion of one or more sterols comprising, consisting essentially of, or consisting of: (a) a suspension of one or more sterols in one or more oil components; and (b) an aqueous solution, wherein the one or more oil component is an animal oil, a plant oil, a mineral oil or a combination of two or more thereof.

The stable dispersion may consist essentially of: (a) a suspension of stigmasterol in an animal oil, a plant oil, a mineral oil or a combination of two or more thereof; and (b) an aqueous solution, which consists essentially of water, sweetener, flavor, alcohol, and crystal growth modifier.

The stable dispersion may consist of: (a) a suspension of stigmasterol in an animal oil, a plant oil, a mineral oil or a combination of two or more thereof; and (b) an aqueous solution, which consists of water.

Certain terms as used herein have particular meaning as prescribed in the discussion below.

The use of a stable nucleator is critical in situations where predictable and long term (i.e., from 10 minutes to 6 months or more) stability is required for ice nucleators. Sterols are a class of compounds that meet this requirement and are used in the stable dispersion of this invention.

Sterols are common organic compounds comprising a perhydro-1,2-cyclopenteneo-phenanthrene four-ringed structure. Sterols may be obtained from animal or plant sources. Suitable sterols for use in this invention may be obtained from plant sources and are known as phytosterols (structure I).

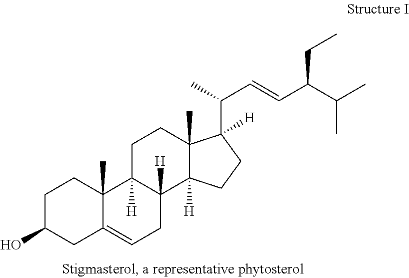

Phytosterols suitable for the present invention have a hydroxyl-substitution at position 3 (most often in the -β-orientation) and are commonly substituted with simple alkyls at the 10, 13 and 17 positions (most commonly at position 17). The substituents on the ring, their orientations, salt forms and other known variations of the basic ring are not critical to this invention.

Sterols, used as the nucleating agents herein, are commercially available from a variety of chemical supply houses such as Sigma Chemical Co. in St. Louis, Mo., The Upjohn Co. in Kalamazoo, Mich. or U.S. Biochemical Co. in Cleveland, Ohio. Sterols, including phytosterols, are provided as solid particles, powder or crystals. A representative list of phytosterols, suitable for use in the present invention, includes but is not limited to: sitosterol, stigmasterol, campesterol, brassicasterol, desmosterol, chalinosterol, poriferasteol, avenasterol, ergosterol, clionasterol and their corresponding stanols.

In an embodiment, stigmasterol is the sterol used as the ice nucleating agent in the present invention. In another embodiment, in addition to the stigmasterol, one or more other sterols may be used.

An effective one or more sterols is a stigmasterol-rich phytosterol composition comprising stigmasterol in the anhydrous form, rather than a hydrated form, or a solvated form, or combination of these forms, to provide stable, reliable and reproducible ice formation to form ready-to-pour frozen slush beverages. Co-pending U.S. patent application Ser. No. 13/423,371 (filed on Mar. 19, 2012, incorporated herein by reference) describes a stigmasterol-rich phytosterol composition comprising stigmasterol in the anhydrous form and its preparation, and use of such composition to prepare ready-to-pour frozen beverages.

In an embodiment of the present invention, stigmasterol comprising 95% stigmasterol and 5% various other sterols from Vita Solar Co. (China), which is in powder form, may be used. This powdered stigmasterol may be heated to allow for stabilization of the sterol. Heating may be performed on a hot plate, or in an oven, fluidized bed, tumble dryer, or by other means that can be readily ascertained by one skilled in the art. Heating may occur in the presence or absence of oxygen or under vacuum. The powdered stigmasterol may be charged to a container, i.e., a flask, tray, or any other container that fits within the dimensions of the oven or other equipment used for heating and that can tolerate the temperature applied. In the heating process, time, temperature, and pressure are interdependent variables. For example, as will be appreciated by one skilled in the art, a higher temperature will require less time, and analogously, a lower temperature will require more time to stabilize the sterol. Similarly, heating under vacuum will require less time than heating at the same temperature but under ambient pressure.

In one embodiment heating of the stigmasterol may be performed in a vacuum oven, for example, with pressure of 0.1 to 14.7 psia (690 Pa to 101 kPa). The temperature during the heating process may be from about 120° C. to about 140° C. Heating may take from about 1 hour to about 96 hours. In another embodiment, the stigmasterol may be heated in an oven under full vacuum (pressure of less than 0.1 psia (690 Pa)) for 3 days.

In the present invention, the one or more sterols functions as an ice nucleating agent in a ready-to-pour frozen slush beverage. An “ice nucleating agent”, as used herein, is defined as a component that is added to a beverage to initiate the freezing process and ensure that the beverage freezes at temperatures typically encountered in domestic freezers. It is well known in the art that water typically cools well below its melting point before freezing, which is known as supercooling. Supercooling can be as great as many degrees below the melting point, and can be inconsistent. Induced ice nucleation is important to prevent excessive supercooling of aqueous solutions, and to provide reliable freezing at typical domestic freezer temperatures. Thus, ice particles with a palatable textured slush or spoonable ice, rather than a solid frozen product, can be obtained.

The terms “induced nucleating” or “induced nucleation”, as used herein, refer to the process of ice crystal formation catalyzed by the use of a composition other than ice. A “nucleator” as used herein, refers to a compound that induces and/or expedites formation of ice in a solution.

An “oil component”, as used herein, refers to a component that is repelled by water, is substantially nonpolar and insoluble in an aqueous solution but soluble in organic solvents. The oil component of this invention is an animal oil, a plant oil, mineral oil, or a combination of two or more thereof.

A variety of oil components from animal or plant sources may be used in the stable dispersion of the present invention. In one embodiment, the oil component is a plant oil. The plant oil may be selected from the group consisting of olive oil, rapeseed oil, canola oil, corn oil, safflower oil, sunflower oil, peanut oil, cottonseed oil, palm oil, soybean oil, coconut oil, rice bran oil, sesame oil, castor oil, avocado oil, grape seed oil and nut oils such as almond, pine nut, cashew, pecan, walnut, Brazil nut, hazel nut, macadamia nut and combinations of two or more thereof.

In one embodiment, the oil component is a animal oil. The animal oil may be selected from the group consisting of: dairy cream, fish oils, butter, ghee, and lard, and combinations of two or more thereof.

In one embodiment, the oil used in the sterol/oil suspension is rapeseed oil. In another embodiment, other additional oil components can be added to the sterol/rapeseed oil suspension.

In one embodiment, the oil used in the sterol/oil suspension is dairy cream. In another embodiment, other additional oil components can be added to the sterol/dairy cream oil suspension.

In one embodiment, the oil used in the sterol/oil suspension is mineral oil. In another embodiment, other additional oil components can be added to the sterol/mineral oil suspension.

The oil component(s) acts as a carrier for the sterol in an aqueous solution. The term “carrier”, as used herein, refers to one or more oil components that when combined with one or more sterols, produces a sterol/oil suspension. The term “suspension”, as used herein, refers to a mixture of solid sterol particles distributed substantially uniformly throughout a continuous liquid phase, which, as used herein, is an oil.

An aqueous solution is combined with the sterol/oil suspension followed by subsequent mixing and homogenizing of the suspension/aqueous solution to produce a stable dispersion of the one or more sterols in the aqueous solution (stable sterol/oil/aqueous dispersion).

In one embodiment, an amount of the one or more oil components is combined with the one or more sterols so that the amount of the one or more sterols suspended in the oil is from about 0.5% to about 30% of the total mass of the sterol/oil suspension. In another embodiment the amount of the one or more oil components is such that the amount of the one or more sterols suspended in the one or more oil components is from about 5% to about 10% of the total mass of the sterol/oil suspension.

The term “aqueous solution” as used herein refers to water or a mixture of water and other components in which the components are totally dissolved by the water and do not phase separate or precipitate. In one embodiment the aqueous solution consists of water. In one embodiment the aqueous solution comprises alcohol. The terms “alcohol” and “alcoholic” denote ethanol or ethyl alcohol found in all forms of comestible alcohols and alcoholic beverages. The aqueous solution may also comprise flavors, sweeteners, crystal growth modifiers, emulsifiers, food colors, acidulants, pH adjusting agents, stabilizers, and combinations of two or more thereof.

The aqueous solution may consist of or consist essentially of water. The aqueous solution may consist essentially of or consist of water, sweetener, flavor, alcohol, and crystal growth modifier. While each of sweetener, flavor, and crystal growth modifier are written in singular form, each is meant herein to include one or more than one sweetener, flavor, and crystal growth modifier, respectively. That is, for example, an aqueous solution may contain one or more sweeteners or one or more flavors or one or more crystal growth modifiers and any combination thereof, when the aqueous solution consists of water, sweetener, flavor, alcohol, and crystal growth modifier.

The aqueous solution may also consist essentially of or consist of water, flavor, sweetener, crystal growth modifier, emulsifier, food color, acidulant, pH adjusting agent, and stabilizer, wherein the singular form of the noun is meant to include one or more than one of the flavor, sweetener, crystal growth modifier, emulsifier, food color, acidulant, pH adjusting agent, and stabilizer.

It will be appreciated by those skilled in the art that the freezing point of the aqueous solution varies with composition of optional components and with their concentrations, such that an aqueous solution that is a mixture of water and other components will have a freezing point less than that of pure water, 0° C.

The stable dispersion may be a beverage. More particularly, the stable dispersion may be a ready-to-pour frozen slush beverage. Still more particularly, the stable dispersion may be a ready-to-pour frozen slush beverage in which the aqueous solution comprises alcohol. When the aqueous solution comprises alcohol, and the stable dispersion is a beverage, the beverage may have proof ranging from 4 to 80, more preferably between 8 to 56 and most preferably between 12 to 40. Alcohol is known to depress the freezing point of a liquid, however, the freezing point depression associated with the percentage of alcohol employed in producing a beverage of this invention does not negatively impact the dispersion in terms of production, distribution and storage, or its organoleptic properties.

The melting point of a beverage according to this invention varies depending on the beverage composition. For all beverages according to this invention, the temperature for refrigeration sufficient for ice to form in the beverage is less than 0° C., preferably in the range of −11° C. to −20° C., most preferably from −14° C. to −20° C., for a period sufficient to freeze the water in the beverage such that the liquid converts to a pourable slush. Actual liquid freezing point may be, for example, −5° C. to −10° C.

The term “ready-to-pour frozen slush beverage” or “slush” refers to a stable dispersion according to this invention which is a beverage. Such a beverage consistently (greater than 99 times out of 100) freezes over a wide range of temperatures (e.g., −11° C. to −20° C.), typically encountered in domestic and commercial freezers, and that when the beverage is removed from the freezer it can be poured out of its container without the need for using an implement such as a spoon by hand, or heat exertion, or waiting for the product to partially melt. For example, the beverage may be cooled to a temperature below its melting point, preferably in the range of −11° C. to −20° C., to form a ready-to-pour frozen slush beverage that is ready for consumption. Spoonable ice products will freeze under similar conditions and remain soft enough to be spooned from their container.

The terms “dispersed” and “dispersion”, as used herein, refer to the distribution of a particulate phase or phases, solid particles, or droplets, substantially uniformly throughout a liquid continuous phase. The liquid continuous phase in the stable dispersion of this invention is the aqueous solution. The particles in the stable dispersion of this invention are sterol particles, in particular, sterol particles that have been suspended in one or more oil components.

The term “stable dispersion” or “stable dispersion of one or more sterols in an aqueous solution”, as used herein, refers to a liquid phase based on the aqueous solution in which sterol particles are not dissolved, but are dispersed and do not settle or separate from the liquid phase; and do not form aggregates when the dispersion is not agitated or subjected to agitation for a period of less than 5 seconds. Further, the sterol particles do not precipitate or form aggregates when subjected to a temperature above the freezing point and below the boiling point (e.g., 0° C.-100° C.) of the aqueous solution, for at least a month; and the particles remain as dispersed particles in the aqueous solution during storage.

As used herein “storage” refers to the period from when the stable dispersion of sterols in the aqueous solution is produced to when it is frozen. The period of storage can be from 10 minutes to 6 months or more. Furthermore, the sterol/oil/aqueous solution stable dispersion may be used as a component of a ready-to-pour frozen slush beverage that can be produced using common domestic or industrial freezers or other cooling equipment or by reducing the temperature by other means. The term “frozen” as used herein, refers to complete or partial conversion of a liquid, including a liquid dispersion, to a spoonable ice product or a slush as the temperature decreases below the liquid's melting point.

In the present invention, it is desirable to produce a stable dispersion of the one or more sterols in the aqueous solution. Without a stable dispersion, an excess of sterol would be required for each use, for example, in a frozen slush beverage to assure presence of sufficient sterol in each beverage to nucleate the ice. Stable dispersions according to the present invention allow for use of less sterol in a ready-to-pour frozen slush beverage. Stable dispersions according to the present invention also facilitate automated dispensing of sterol, in the form of the stable dispersion, to accelerate beverage bottling and product packaging processes. The stable dispersions are essentially homogeneous, so the dispersion can be made and bottled directly with standard equipment and at full bottling line speeds. For unstable suspensions, the sterol would have to be added to each bottle separately to insure the presence of an adequate amount in each. This separate dosing would require specialized equipment and would slow bottling speeds.

While not wishing to be bound by theory, stability of the stable dispersion of one or more sterols of the present invention is believed to be possible because the sterol(s) is present as a suspension in one or more oil components, which function as a carrier, as disclosed herein. Sterol crystals are generally dominated by large, hydrophobic crystal faces. Smaller, hydrophilic faces make up far less of the surface area of the crystals. These hydrophilic faces are believed to be responsible for ice nucleation. In the absence of a carrier, such as the oil component(s) used herein, when placed in water or aqueous solution, the hydrophobic faces of the sterol crystal may attach themselves to the hydrophobic faces of other sterol crystals, producing large aggregates of sterol crystals. Alternatively, in the absence of a carrier, the hydrophobic faces of the sterol crystals in water or aqueous solution, may attach to the air/liquid (where liquid is water or aqueous solution) interface, causing the sterol to “float” on top of the liquid. In yet another alternative, in the absence of a carrier, the hydrophobic faces of the sterol crystal may attach to the container holding the water or aqueous solution, causing the sterol to sit on the bottom of the container.

When one or more oil components is combined with the sterol as provided in the suspension as described herein, once the suspension is added to water or an aqueous solution, the hydrophobic sterol crystal faces have a coating around them. The coating of the hydrophobic faces reduces sterol crystals tendency to attach to each other, or to the air/liquid interface, or to the container surfaces, thus making the oil coated sterol easier to disperse into the liquid. Unexpectedly, the presence of one or more oils in the sterol/oil suspension has no adverse effects on the ability of the one or more sterols to nucleate ice crystallization in the sterol/oil/aqueous solution, as a theory suggests coating of sterol crystals inhibits their ability to function as ice nucleators. Thus, it is believed according to this inventions, upon homogenizing, sterols are dispersed in an aqueous solution in the presence of oils to provide a stable dispersion in the aqueous phase.

In the dispersion of the present invention, a wide concentration range of sterols, may be used. Since ice crystals also serve as nucleation sites, in principle only enough sterol, i.e., a single sterol crystal, is needed to nucleate a single ice crystal, which can then nucleate additional ice crystals, with this process continuing to form additional ice crystals. In practice, enough sterol is needed to nucleate a few ice crystals at various locations within the dispersion.

In one embodiment, the concentration of the one or more sterols in the stable dispersion is in an amount of about 1 mg/L or more, about 10 mg/L or more, or about 40 mg/L or more, and in an amount of about 1500 mg/L or less, about 1000 mg/L or less, about 500 mg/L or less. In another embodiment, the concentration of the one or more sterols in the dispersion is from about 1 mg/L to about 1500 mg/L. In yet another embodiment, the concentration of the one or more sterols in the dispersion is from about 10 mg/L to about 1000 mg/L. In yet another embodiment, the concentration of the one or more sterols in the dispersion is from about 40 mg/L to about 500 mg/L.

In a further aspect of the invention, the one or more oil component is dairy cream.

The present invention provides a process to produce a stable dispersion of one or more sterols in an aqueous solution. This process comprises, consists essentially of, or consists of: (a) combining one or more sterols with one or more oil components, to produce a sterol/oil suspension, wherein the one or more oil component is an animal oil, a plant oil, a mineral oil or a combination of two or more thereof; (b) combining the sterol/oil suspension with an aqueous solution to produce a mixture of sterol/oil/aqueous solution; (c) agitating the mixture of sterol/oil/aqueous solution to produce an unstable dispersion of sterol/oil/aqueous solution; and (d) homogenizing the unstable dispersion of step (c) to produce a stable dispersion of the one or more sterols in the aqueous solution.

The process may consist essentially of: (a) combining one or more sterols with one or more oil components, to produce a sterol/oil suspension, wherein the one or more oil component is an animal oil, a plant oil, a mineral oil or a combination of two or more thereof; (b) combining the sterol/oil suspension with an aqueous solution, which consists essentially of water, sweetener, flavor, alcohol, and crystal growth modifier to produce a mixture of sterol/oil/aqueous solution; (c) agitating the mixture of sterol/oil/aqueous solution to produce an unstable dispersion of sterol/oil/aqueous solution wherein agitating is performed by manual shaking, by mechanically stirring with an impeller or by using a vortex mixer; and (d) homogenizing the unstable dispersion of step (c) wherein homogenizing is performed by high-pressure homogenizing, high shear mixing, sonicating to produce a stable dispersion of the one or more sterols in the aqueous solution.

The process may consist of: (a) combining stigmasterol with an animal oil, a plant oil, a mineral oil or a combination of two or more thereof to produce a sterol/oil suspension; (b) combining the sterol/oil suspension with an aqueous solution, which consists of water, sweetener, flavor, alcohol, and crystal growth modifier to produce a mixture of sterol/oil/aqueous solution; (c) agitating the mixture of sterol/oil/aqueous solution to produce an unstable dispersion of sterol/oil/aqueous solution wherein agitating is performed by manual shaking, by mechanically stirring with an impeller or by using a vortex mixer; and (d) homogenizing the unstable dispersion of step (c) wherein homogenizing is performed by high-pressure homogenizing, to produce a stable dispersion of the stigmasterol in the aqueous solution.

Surprisingly by combining the one or more sterols with one or more oil components to first produce a sterol/oil suspension and then combining the suspension with an aqueous solution and agitating (mixing) then homogenizing, a stable dispersion in which the sterol(s) does not separate from the aqueous solution is produced.

In a first step, one or more sterols is combined with one or more oil components. In this step, the sterol(s) and oil(s) may be combined in any manner such that the sterol is suspended in the oil. In general, no particular method of combining and/or mixing is required. Mixing may be performed, for example, manually or using mechanical mixing equipment.

The mixture of sterol/oil/aqueous solution is agitated for a specified amount of time producing an unstable dispersion of sterol/oil/aqueous solution. The unstable dispersion lacks the properties of the stable dispersion of this invention. That is, sterol particles precipitate or separate from the aqueous solution when subjected to storage or temperature changes. “Agitation” or “agitate”, as used herein, involves low intensity mixing and may be performed by manual shaking, by mechanically stirring with an impeller or by using a vortex mixer. The agitation duration of the unstable dispersion of sterol/oil/aqueous solution may vary from about 5 seconds to 10 minutes or longer.

The unstable dispersion sterol/oil/aqueous solution thus formed is homogenized to produce a stable dispersion of one or more sterols in the aqueous solution. The term “homogenization”, as used herein, means processing the mixture using high intensity mixing in such a way that the oil/sterol suspension is broken-up into very small, relatively uniformly sized droplets in a continuous phase comprised by the aqueous solution.

Homogenization may be performed using a variety of equipment that provides intense mixing to breakup the oil/sterol suspension into small droplets in the aqueous solution. Homogenization may take about 10 seconds to about 10 minutes. Homogenizing technologies available to perform the step to uniformly disperse the sterol/oil suspension in the aqueous solution include, but are not limited to, high-pressure homogenizing, high shear mixing, or sonicating. Other mixing techniques which rely on intense mixing are known to those skilled in the art and may also be used. Homogenizers, high shear mixers and sonicators are commercially available.

Homogenization may be performed batch-wise by operating a high speed agitator element of a high shear mixer, wherein the agitator element is immersed in the unstable dispersion. Homogenization may be performed by sonicating using a piezoelectric element or by forcing fluids past a blade that then vibrates at sonic or ultrasonic frequency. Such methods are widely used for homogenization. Homogenization may be performed in a continuous manner using a high pressure homogenizer by forcing the dispersion at high pressure through a device that produces high hydrodynamic shear in the dispersion. For example, an APV 2000 homogenizer (Invensys APV, Denmark) may be used with a pressure of from about 10,000 psi (69 MPa) to about 20,000 psi (138 MPa) and a flow rate of about 11 liters per hour thus producing a stable sterol/oil/aqueous dispersion. The homogenized stable sterol/oil/aqueous dispersion may then be poured into a container and placed in storage. The container of the stable dispersion may be placed in a freezer or otherwise the temperature of the dispersion may be reduced to below its melting point.

The stable dispersion may be diluted by adding to the stable dispersion an additional quantity of an aqueous solution, wherein the aqueous solution is the same as or different from the aqueous solution added in step (b), and mixing the stable dispersion with the added aqueous solution, thus producing a diluted stable dispersion. The aqueous solution is as defined hereinabove. The composition of the added aqueous solution used to dilute the stable dispersion is selected so that the composition of the diluted stable dispersion is as desired for a final product to be stored and/or sold.

In the dilution step, the additional quantity of aqueous solution may be up to an amount to provide a mass ratio of 15,000:1 additional aqueous solution to stable sterol/oil/aqueous dispersion. The amount of additional aqueous solution varies based on the concentration of sterol in the stable sterol dispersion and the desired concentration of sterol in the final product that will provide desired ice nucleation performance.

The sterol/oil suspension is then combined with an aqueous solution to provide a mixture of sterol/oil/aqueous solution. The amount of aqueous solution combined with the sterol/oil suspension varies and is typically between 95 and 99.99% of the total mass of this mixture. This mixture may then be diluted with additional aqueous solution, and thus the amount of aqueous solution in the final product is typically at least between 95 and 99.99% of the total mass of the stable dispersion. The amount of aqueous solution in the final stable dispersion after dilution may be greater than 99.99% of the total mass of the stable dispersion.

Finally, the process may comprise bottling or packaging the stable dispersion or the diluted stable dispersion.

When the stable dispersion is a beverage, the process may further comprise freezing the stable dispersion by cooling to a temperature below the melting point of the stable dispersion, preferably in the range of −11° C. to −20° C., to form a ready-to-pour frozen slush beverage that is ready for consumption.

The advantageous attributes and effects of the dispersion and process disclosed herein may be more fully appreciated from the Examples described below. The embodiments of the dispersion and process on which the Examples are based are representative only, and the selection of those embodiments to illustrate the invention does not indicate that materials, components, reactants, conditions, specifications, steps or techniques not described in the Examples are not suitable for practicing these processes, or that subject matter not described in the Examples is excluded from the scope of the appended claims and equivalents thereof.

### EXAMPLES

### Example 1

### Rapeseed Oil Used as a Carrier to Disperse Stigmasterol in an Aqueous Solution

The purpose of this example was to evaluate using the rapeseed oil as a carrier to disperse stigmasterol throughout an ethanol/water aqueous solution without negatively impacting the nucleation ability of the stigmasterol. The experiment was performed as described below:
1. 30 milligram (mg) of a powder stigmasterol (95% powder stigmasterol with the other 5% consisting of various other sterols from Vita Solar, E-2704 Van Metropolis, No. 35 Tangyan Rd., High-tech Industries Development Zone,Xi'an 710075, China) was placed in a aluminum pan and was subjected to 135° C. under full vacuum in an oven for three days.
2. The heat-treated stigmasterol was added to varying quantities of rapeseed oil in order to achieve 5% -10% stigmasterol solids in rapeseed oil in a 20 ml scintillation vial to produce a stigmasterol/rapeseed oil suspension.
3. The stigmasterol/rapeseed oil suspension of step 2 was added to 100 ml aqueous solution of 16% volume/volume ethanol/water mixture in a 100 ml glass bottle to produce a mixture of stigmasterol/rapeseed oil/aqueous solution.
4. The mixture of stigmasterol/rapeseed oil/aqueous solution of step 3, in the 100 ml glass bottle, was then shaken by hand for 20 seconds.
5. The shaken mixture (unstable dispersion) of stigmasterol/rapeseed oil/aqueous solution of step 4 was slowly fed into an APV-2000 homogenizer (APV Fluid Handling and Homogenizers, Delavan, Wis., USA) operating between 12,000-20,000 psi (83-138 MPa) to produce a stable dispersion of stigmasterol/rapeseed oil/aqueous solution.
6. The stable dispersion of stigmasterol/rapeseed oil/aqueous solution of step 5 leaving the homogenizer was further diluted by adding 20 ml of the stable dispersion to an additional 100 ml aqueous solution of 16 vol % ethanol in water. This diluted dispersion was then submitted to freeze testing to insure that the ability of the stigmasterol to nucleate ice was not negatively impacted by either the presence of the rapeseed oil or the process used to obtain the homogenized stable dispersion.
7. The freeze test consisted of subjecting the homogenized stable dispersion in the 100 ml bottles to a range of freezing temperatures between −11 to −20° C.
8. After 24 hours in the freezer, the bottles were removed and inspected. Contents of all bottles were frozen.
9. In cases where the bottles containing stable dispersion of stigmasterol/rapeseed oil/aqueous solution were left stationary at room temperature (−25° C.), for greater than 6 months, stigmasterol remained dispersed in the ethanol/water aqueous solution.

This Example demonstrates that using the described dispersion and process, stigmasterol remained dispersed in the ethanol/water aqueous solution for several months. The addition of rapeseed oil and the manipulations described above did not negatively impact the nucleation of the ethanol/water aqueous solution by the sterol/oil suspension demonstrating that a very stable dispersion of stigmasterol in a 16% ethanol/water aqueous solution was achieved by first producing a suspension of stigmasterol in the rapeseed oil.

### Example 2

Dairy Cream Used as a Carrier to Disperse Stigmasterol in an Aqueous Solution

The purpose of this Example was to evaluate using dairy cream oil as a carrier to disperse stigmasterol throughout an ethanol/water aqueous solution without negatively impacting the nucleation ability of the stigmasterol. The experiment was performed as described below:
1. 30 milligram (mg) of a powder stigmasterol (95% powder stigmasterol with the other 5% consisting of various other sterols from Vita Solar, E-2704 Van Metropolis, No. 35 Tangyan Rd., High-tech Industries Development Zone,Xi'an 710075, China) was placed in a aluminum pan and was subjected to 135° C. under full vacuum in an oven for three days.
2. The heat-treated stigmasterol was added to varying quantities of dairy cream in order to achieve 5% -10% stigmasterol solids in dairy cream in a 20 ml scintillation vial to produce a stigmasterol/dairy cream suspension.
3. The stigmasterol/dairy cream suspension of step 2 was added to 100 ml of 16% volume/volume ethanol/water aqueous solution in a 100 ml glass bottle to produce a mixture of stigmasterol/dairy cream/aqueous solution.
4. The mixture of stigmasterol/dairy cream/aqueous solution of step 3, in the 100 ml glass bottle, was then shaken by hand for 20 seconds.
5. The shaken mixture (unstable dispersion) of stigmasterol/dairy cream/aqueous solution of step 4 was slowly fed into an APV-2000 homogenizer (APV Fluid Handling and Homogenizers, Delavan, Wis., USA) operating between 12,000-20,000 psi (83-138 MPa) to produce a stable dispersion of stigmasterol/dairy cream/aqueous solution.
6. The stable dispersion of stigmasterol/dairy cream/aqueous solution of step 5 leaving the homogenizer was further diluted by adding 20 ml of the stable dispersion to an additional 100 ml aqueous solution of 16 vol % ethanol in water. This diluted dispersion was then submitted to freeze testing to insure that the ability of the stigmasterol to nucleate ice was not negatively impacted by either the presence of the dairy cream or the process used to obtain the homogenized stable dispersion.
7. The freeze test consisted of subjecting the homogenized stable dispersion in the 100 ml bottles to a range of freezing temperatures between −11 to −20° C.
8. After twenty four hours in the freezer, the bottles were removed and inspected. Contents of all bottles were frozen.
9. In cases where the bottles containing stable dispersion of stigmasterol/dairy cream/aqueous solution were left stationary at room temperature (˜25° C.), for greater than 6 months, stigmasterol remained dispersed in the ethanol/water aqueous solution.

This example demonstrates that using the described formulation and process stigmasterol can remain suspended in the ethanol/water mixture for several months. The addition of dairy cream and the manipulations described above did not negatively impact the nucleation of the ethanol/water by the emulsified suspension underlining that a very stable suspension of stigmasterol in a 16% ethanol/water mixture can be achieved using the process described above.

This Example demonstrates that using the described dispersion and process, stigmasterol remained dispersed in the ethanol/water aqueous solution for several months. The addition of dairy cream and the manipulations described above did not negatively impact the nucleation of the ethanol/water aqueous solution by the sterol/dairy cream suspension demonstrating that a very stable dispersion of stigmasterol in a 16% ethanol/water aqueous solution was achieved by first producing a suspension of stigmasterol in the dairy cream.

### Comparative Example

### Unstable Sterol Dispersions in Frozen Slush Beverages

A slush beverage was prepared according to Winston, et al., WO 2010/146392 and a slush beverage was prepared according to Green, et al., U.S. patent application Ser. No. 13/423,371. Stigmasterol was used as an ice nucleator in each beverage. In the beverage based on Green, et al., the stigmasterol was anhydrous. The slush beverages were placed in a domestic freezer at a temperature of about −11° C. to −20° C. The beverages were removed from the freezer. After allowing the beverages to melt, forming liquid, solid particles of stigmasterol were found on the top surfaces of each melted beverage. This visible presence of stigmasterol could be perceived by the consumer as a defect.

### Example 3

### Stable Sterol Dispersions in Frozen Slush Beverages

A slush beverage is prepared similar to those in the Comparative

Example, however, the stigmasterol used is a stable sterol suspension prepared according to Example 1. The slush beverage is placed in a domestic freezer at a temperature of about −11° C. to −20° C. The beverage is removed from the freezer. After allowing the beverages to melt, forming liquid, no solid particles of stigmasterol are found on the top surfaces of the melted beverage.

What is claimed is:

1. A stable dispersion of one or more sterols comprising:
a) a suspension of one or more sterols in one or more oil component; and
b) an aqueous solution,
wherein the oil component is an animal oil, a plant oil or a combination of two or more thereof.

2. The stable dispersion of claim 1 wherein the aqueous solution consists of water.

3. The stable dispersion of claim 1 wherein the aqueous solution comprises alcohol.

4. The stable dispersion of claim 1 wherein the one or more sterols is a phytosterol.

5. The stable dispersion of claim 4 wherein the phytosterol is selected from the group consisting of sitosterol, stigmasterol, campesterol, brassicasterol, desmosterol, chalinosterol, poriferasteol, avenasterol, ergosterol, clionasterol and their corresponding stanols.

6. The stable dispersion of claim 5 wherein the one or more sterols is stigmasterol.

7. The stable dispersion of claim 6 wherein the concentration of the stigmasterol in the suspension is from about 1 mg/l to 1500 mg/l of the total suspension mass.

8. The stable dispersion of claim 4 wherein the one or more sterols is a stigmasterol-rich phytosterol composition comprising stigmasterol in the anhydrous form.

9. The stable dispersion of claim 1 wherein the one or more oil component is selected from the group consisting of olive oil, rapeseed oil, canola oil, corn oil, safflower oil, sunflower oil, peanut oil, cottonseed oil, palm oil, soybean oil, coconut oil, rice bran oil, sesame oil, castor oil, avocado oil, grape seed oil and nut oils such as almond, pine nut, cashew, pecan, walnut, Brazil nut, hazel nut, and macadamia nut.

10. The stable dispersion of claim 9 wherein the one or more oil components is rapeseed oil.

11. The stable dispersion of claim 1 wherein the one or more oil components is selected from the group consisting of: dairy cream, fish oils, butter, ghee, and lard.

12. The stable dispersion of claim 11 wherein the one or more oil components is dairy cream.

13. The stable dispersion of claim 1 wherein the amount of the aqueous solution in the stable dispersion is between 95% to greater than 99.99% of the total mass of the dispersion.

14. The stable dispersion of claim 1 wherein the stable dispersion is a beverage and such beverage is a ready-to-pour frozen slush beverage.

15. A process for preparing a stable dispersion of one or more sterols comprising the steps:
a) combining one or more sterols with one or more oil components, to produce a sterol/oil suspension;
b) combining the sterol/oil suspension with an aqueous solution to produce a mixture of sterol/oil/aqueous solution;
c) agitating the mixture of sterol/oil/aqueous solution to produce an unstable dispersion of sterol/oil/aqueous solution; and
d) homogenizing the unstable dispersion of step (c) wherein a stable dispersion of the one or more sterols in the aqueous solution is produced.

16. The process of claim 15 further comprising the step of diluting the stable dispersion by adding an additional quantity of an aqueous solution to the stable dispersion, and mixing the stable dispersion with the added aqueous solution, thus producing a diluted stable dispersion.

17. The process of claim 16 further comprising freezing the stable dispersion.

18. The process of claim 15 wherein the amount of aqueous solution combined with the sterol/oil suspension is between 95 and 99.99% of the total mass of the mixture.

19. The process of claim 15 wherein the amount of aqueous solution combined with the sterol/oil suspension is greater than 99.99% of the total mass of the mixture.

20. The process of claim 15 wherein the agitating in step (c) is performed by manual shaking, by mechanically stirring with an impeller or by using a vortex mixer.

21. The process of claim 15 wherein the homogenizing step (d) is performed using high-pressure homogenizing, high shear mixing, or sonicating.

22. The process of claim 15 wherein the homogenizing in step (d) is performed batch-wise by operating a high speed agitator element of a high shear mixer, wherein the agitator element is immersed in the unstable dispersion.

23. The process of claim 15 wherein the homogenizing in step (d) is performed by sonicating using a piezoelectric element or by forcing fluids past a blade that then vibrates at sonic or ultrasonic frequency.

24. The process of claim 15 wherein the homogenizing in step (d) is performed in a continuous manner using a high pressure homogenizer by forcing the dispersion at high pressure through a device that produces high hydrodynamic shear in the dispersion.
